(19) United States
(12) Patent Application Publication
(10) Pub. No.: US 2012/0112452 A1
(43) Pub. Date: May 10, 2012

(54) COMPRESSIBLE EXHAUST CONNECTION MEMBER

(76) Inventors: Robert Franklin STALCUP, II, Covington, IN (US); Scott Robert Swank, Williamsport, IN (US)

(21) Appl. No.: 12/942,828

(22) Filed: Nov. 9, 2010

(51) Int. Cl. F16L 27/103

(52) U.S. Cl. 285/145.5

(57) ABSTRACT

An exhaust connection coupler and a method for manufacturing the same are provided. The coupler may include a bellows member, an interlock member disposed within the bellows member and an outer braid cover surrounding the bellows member. The braid cover is designed such that it provides resistance limiting axial growth of the coupler, so that the interlock member is not extended to an excessive length, while enabling maximized compression and angular flexibility. The outer braid cover may be constructed of intertwined bundles of wire filaments disposed at a specified angle from a central axis of the coupler. As assembled, the interlock member is at a nearly fully extended length when the bellows member is at an uncompressed and unextended length in order to maximize the amount in which the coupler may be compressed and/or flexed during installation and use.

### CROSS-REFERENCE TO RELATED APPLICATIONS

None.

### BACKGROUND OF THE INVENTION

As is generally known, some automotive exhaust systems employ a flexible connection member or coupler disposed between two exhaust pipes in order to absorb undesirable vibrations input into the exhaust piping, absorb any thermal expansion or contraction of the exhaust piping, and compensate for any misalignments in the exhaust piping. These couplers are generally formed of a flexible metal bellows member and a braid cover surrounding the outer periphery of the bellows member. Exemplary of such a coupler is U.S. Pat. No. 5,769,463 to Thomas. The couplers may also include an interlock hose member disposed within the bellows member. Exemplary of such a coupler is U.S. Pat. No. 6,230,748 to Krawietz, et al.

The exhaust pipes, which are connected to each other by the coupler, often move and become misaligned with one another due to various circumstances, such as the flexing of the vehicle's frame as it traverses uneven terrain. Thus, a need exists from a coupler having improved flexibility and compressibility so as to absorb such movement and misalignment. Additionally, couplers having interlock hose members may become broken or damaged as a result of the coupler being excessively extended or compressed. Accordingly, a further need exists for a coupler having a means for limiting the extension or compresion of the interlock hose member so that it will not become broken or damaged as a result of the coupler being extended or compressed too far.

### SUMMARY OF THE INVENTION

The present invention involves the provision of an exhaust connection coupler and a method for manufacturing the same. The coupler may include a flexible bellows member, an axially extendable and contractible interlock member disposed within the bellows member and a braid cover surrounding the bellows member. In one embodiment, the outer braid cover, by its nature, cannot extend or compress without changing diameter. The outer braid cover includes a cross-sectional circumference and an axial length and is constructed such that its circumference constricts radially as its length is extended axially. Such a design results in the outer braid cover becoming constricted against the bellows member when the coupler (and outer braid cover) is extended in length. This constriction against the bellows member serves to limit the amount in which the outer braid cover (and thus the coupler and its components, including the interlock member), may be extended in length. As assembled, the interlock member may generally be at a nearly fully extended length when the bellows member is at a natural, uncompressed and unextended length. Such a design maximizes the amount in which the coupler may be compressed, as the interlock member can be the limiting factor dictating the extent to which the coupler can be compressed. The braid cover may be designed such that it provides resistance limiting the axial growth of the coupler while allowing maximum compression and angular flexibility during installation and use. The braid cover may be constructed of intertwined bundles of wire filaments disposed at a specified angle from a central axis of the coupler.

In one embodiment, the coupler may also include an inner braid member disposed inwardly of the interlock member. Like the outer braid cover, the inner braid member, by its nature, cannot extend or compress without changing diameter. When the coupler is compressed in length axially, the inner braid member expands radially and becomes pressed against the interior of the interlock member. The interior of the interlock member prevents the inner braid member from expanding in diameter any further and thus limits how far the inner braid member (and consequently the coupler and its components, including the interlock member) may be compressed in length. Just as the outer braid cover provides resistance or restriction limiting the axial growth of the coupler, the inner braid member provides resistance or restriction limiting the axial compression of the coupler. The braid cover and braid member may work in tandem to ensure that the coupler will not be stretched or compressed too far thereby aiding to prevent premature failure of the components therein, including the interlock member and bellows member.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a side perspective view of an exhaust connection coupler in accordance with one embodiment of the present invention;

FIG. 2 is an exploded side perspective view of an exhaust connection coupler in accordance with one embodiment of the present invention;

FIG. 3 is an enlarged fragmentary cross-sectional side view of an exhaust connection coupler in an uncompressed, unextended state in accordance with one embodiment of the present invention;

FIG. 4 is an enlarged fragmentary cross-sectional side view of an exhaust connection coupler in a compressed state in accordance with one embodiment of the present invention;

FIG. 5 is an enlarged fragmentary cross-sectional side view of an exhaust connection coupler including an inner braid member in accordance with one embodiment of the present invention;

FIG. 6 is a side perspective view of an exhaust connection coupler in an angularly flexed orientation in accordance with one embodiment of the present invention; and

FIG. 7 is a partially enlarged view illustrating the manner and angle at which bundles of wire elements may be braided in order to form a cover member in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

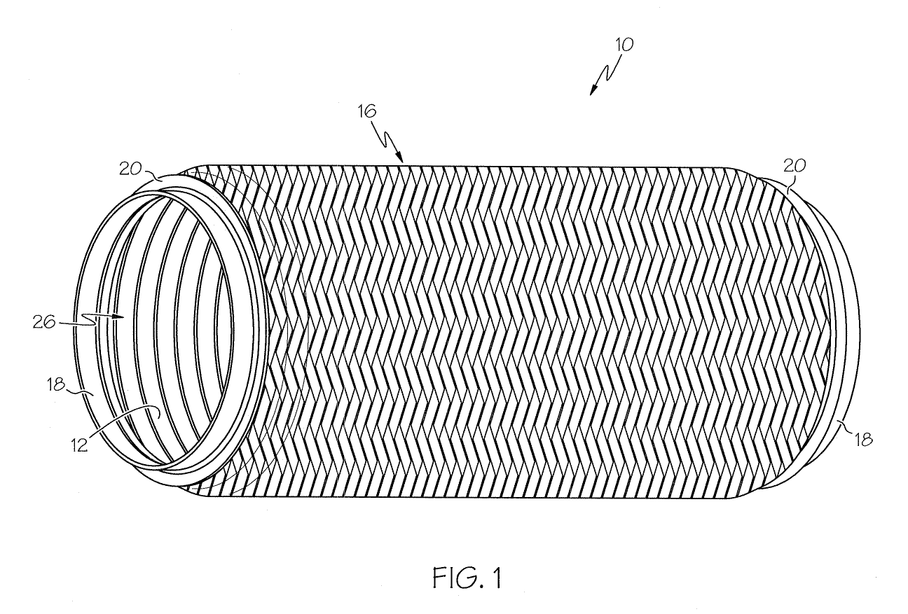

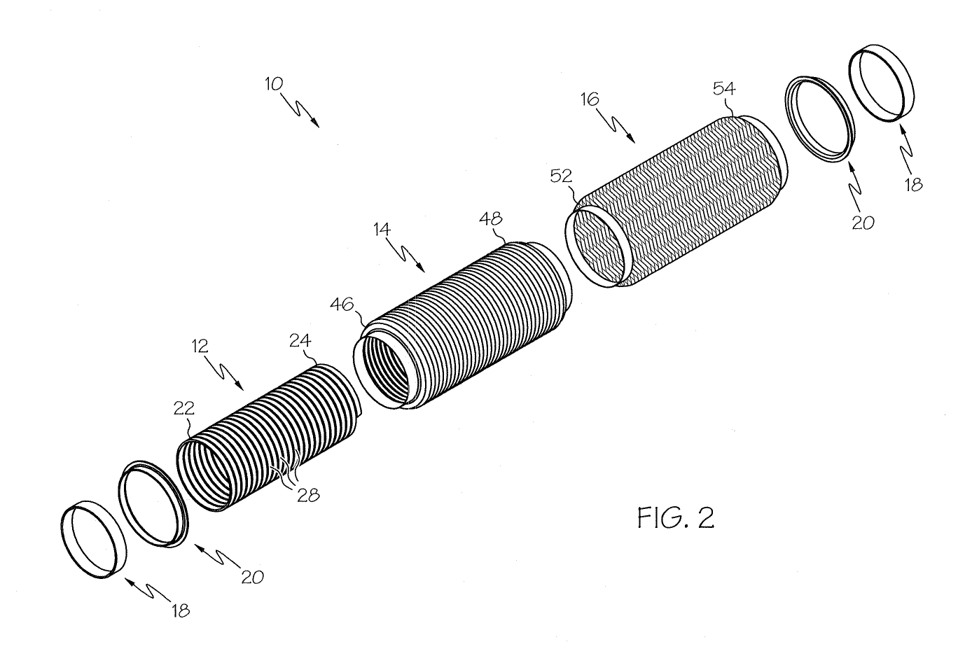

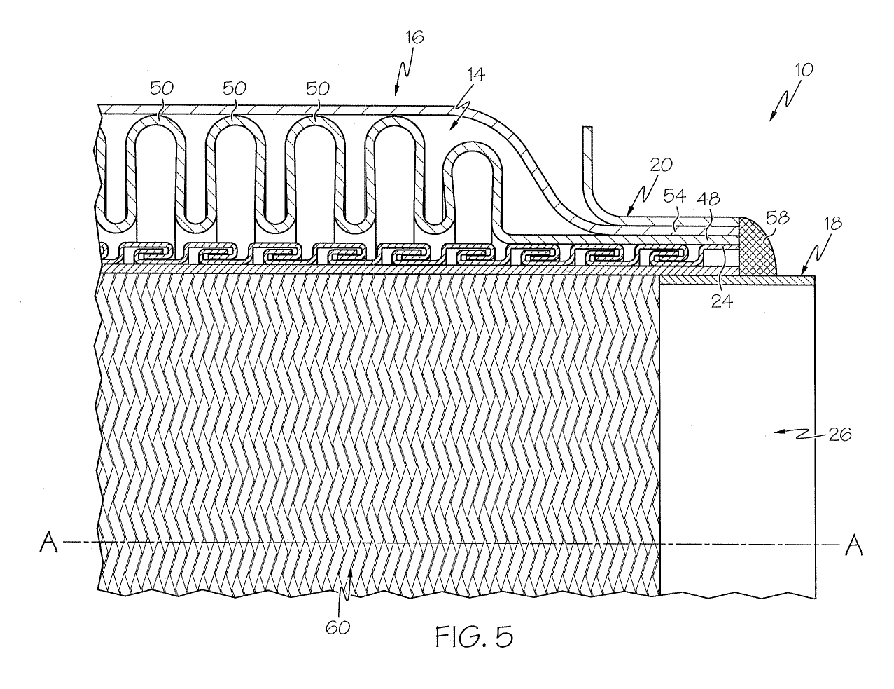

The present invention is directed generally toward an exhaust connection member or coupler 10 and a method for manufacturing the same. As illustrated in FIGS. 1 and 2, the coupler 10 may include an interlock hose member 12, a flexible bellows member 14, a braid cover 16 surrounding the bellows member 14, end flanges 18, and end rings or collars 20 for securing the end parts of the interlock hose member 12, flexible bellows member 14 and braid cover 16 together. The interlock member 12 is disposed within the bellows member 14. The coupler 10 is flexible thereby serving to effectively absorb any linear thermal expansion and contraction of the exhaust piping to which the coupler 10 is connected, absorb undesirable vibrations input into the exhaust piping and compensate for misalignments in the exhaust piping. As shown in FIG. 5 and described in greater detail below, the coupler 10 may further include an interior braid member 60 disposed inwardly of the interlock member 12.

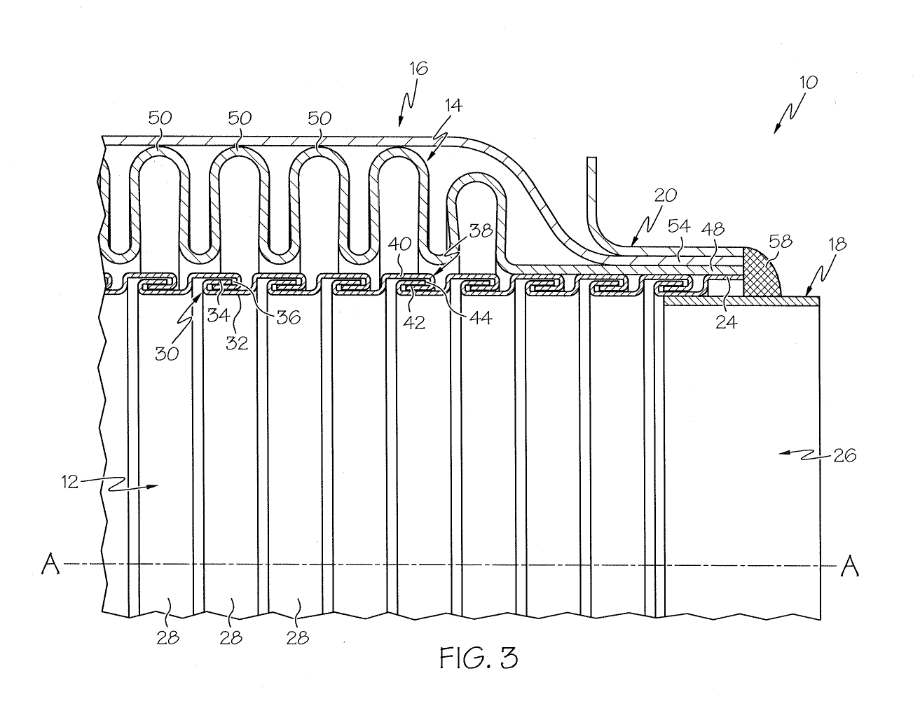

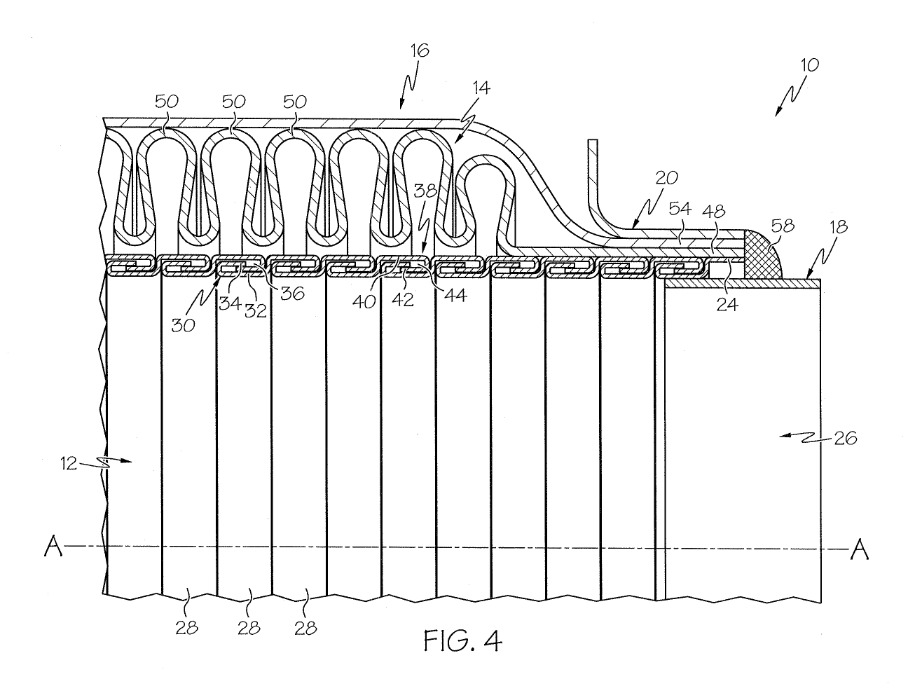

The interlock member 12 is generally flexible and able to accommodate relative movement between the exhaust piping (not shown). It is axially extendable and contractible. The interlock member 12 may be of a type generally known in the industry and may be constructed of a single spirally-wound, interlocking formed metal band 28 having interlocking leading and trailing ends 34 and 42. As depicted in FIGS. 3 and 4, the band 28 is generally formed into an S-shaped configuration having first and second hook portions 30 and 38. The first hook portion 30 is comprised of a generally flat segment 32, a free end 34 and a gap 36 defined therebetween. Likewise, the second hook portion 38 is comprised of a generally flat segment 40, a free end 42 and a gap 44 defined therebetween. As illustrated, the first hook portion 30 of one band 28 interlocks with the second hook portion 38 of an adjacent band 28. The continuous spirally-wound, interlocking band 28 forms a generally cylindrical member having first and second ends 22 and 24. The interlock member 12 defines a passageway 26 through which the exhaust gases flow.

The bellows member 14, which may be formed of a metallic material and may be of a generally cylindrical shape, is comprised of first and second tube-like ends 46 and 48 with a plurality of repeating corrugations 50 extending therebetween. The bellows member 14 is also flexible thereby serving to effectively absorb any linear thermal expansion and contraction of the exhaust piping to which the coupler 10 is connected, absorb undesirable vibrations input into the exhaust piping and compensate for misalignments in the exhaust piping.

As depicted in the figures, the interlock member 12 may be disposed inwardly of the bellows member 14 so as to define a gap therebetween. In one embodiment, there is a circumferential air gap of approximately ⅛ inch between the interlock member 12 and bellows member 14. This gap provides insulation qualities and also permits relative motion and vibration between the interlock member 12 and bellows member 14 without the two creating rubbing against or creating friction between each other.

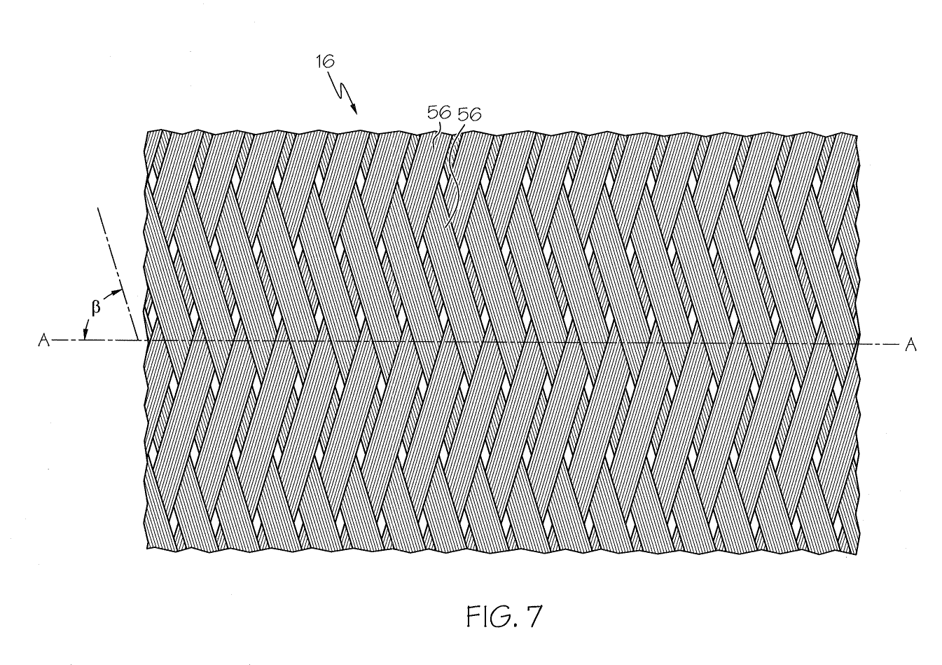

A braid cover 16 having first and second ends 52 and 54 may surround an outer periphery of the bellows member 14. The braid cover 16 serves to dampen vibrations, protect the bellows member 14 and provide resistance limiting axial growth of the coupler 10 while allowing for maximum compression and angular flexibility during installation and use. As shown in FIG. 7, braid member 16 is formed of a plurality of ribbon-like bundles 56 made up of parallel metallic wire filaments. In one embodiment, the bundles 56 are fashioned from a plurality of metal wire filaments that are generally in side-by-side contact with one another to form a substantially solid ribbon. The bundles 56 may be intertwined (e.g., interlaced, braided, knitted, woven, looped or the like) together on an elongated mandrel (not shown) to form a flexible, fabric-type generally cylindrical article.

The braid cover 16 is instrumental in providing resistance or restriction limiting the axial growth of the coupler 10, including the interlock member 12, while allowing for maximum compression and angular flexibility. This promotes prolonged life of the interlock member 12 by restricting it from being stretched too far and potentially breaking or being pulled apart. The construction of the braid cover 16, however, is such that it allows the coupler 10 to be compressed in length and angularly flexed. When compressed, the length of the coupler 10 may be reduced by a length of up to 25% or more of the coupler's 10 naturally uncompressed and unextended length. For example, in one embodiment, the coupler's 10 uncompressed, unextended length is about 12 inches while the coupler 10 has the ability to be compressed to a length of about 10 inches. In some cases, the interlock member 12 is the limiting factor keeping the coupler 10 from being compressed any further. As shown in FIG. 4, when the coupler 10 is fully compressed, the hook portions 30 and 38 of the interlock member 12 are bottomed out against one another.

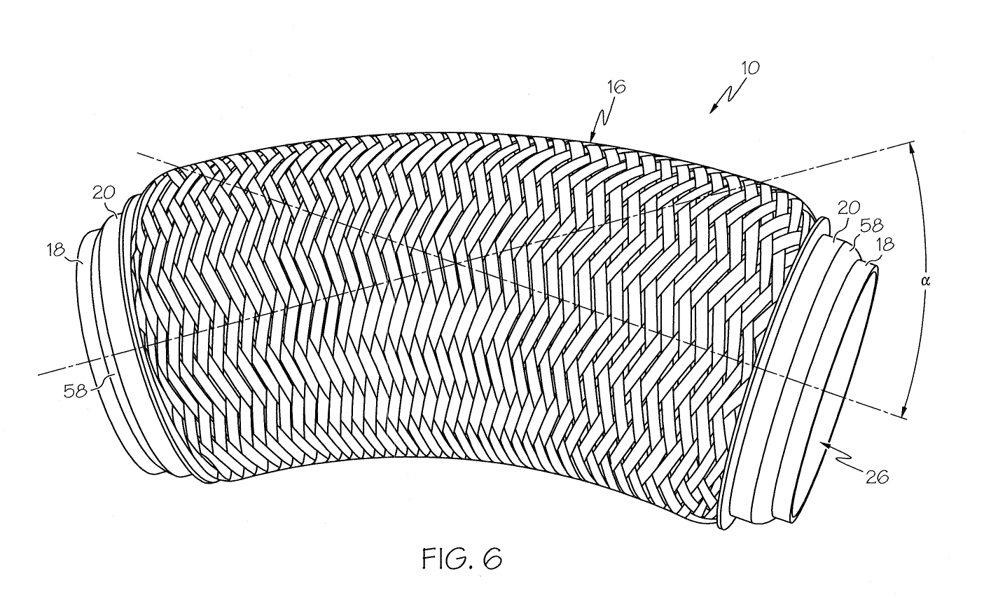

As discussed in further detail below, the interlock member 12 is generally at a nearly fully extended length when the coupler 10, including the bellows member 14, is in its natural uncompressed, unextended length. Such a design affords the coupler 10 the ability to maximize the amount in which it may be compressed because, as mentioned above, the interlock member 12 is may be the limiting factor dictating the extent to which the coupler 10 can be compressed. When the interlock member's 12 hook portions 30 and 38 become bottomed out against one another, like demonstrated in FIG. 4, the coupler 10 may not be compressed any further. This design also affords the coupler 10 a maximized flexibility. As illustrated in FIG. 6, the coupler 10 may be flexed such that it has an angular axial displacement. This is possible because one side of the coupler 10, including the interlock member 12, may be compressed while the other side remains less compressed, uncompressed or even slighted extended from its natural length. The coupler 10 may be axially flexed to an angle α of up to about 45° or more, and in one embodiment up to about 35°, as demonstrated in FIG. 6.

The construction of the braid cover 16, including the angle β at which its bundles 56 are intertwined, affords the braid cover 16 the ability to provide resistance or restriction limiting the coupler's 10 axial growth, while allowing for maximum compression and angular flexibility. As depicted in FIG. 7, the bundles 56 are braided or otherwise arranged at an angle β relative to a central axis A-A of the coupler 10. The angle β can be in a range from about 55° to 80°, and in one embodiment is in a range from about 65° to 75°. In one embodiment, the braid cover 16, by its nature, cannot extend or compress without changing in diameter. When the braid cover 16 is extended in length axially, its cross-sectional circumference constricts radially, and vice versa. As such, the braid cover is not unlike the toys commonly known as “Chinese handcuffs” or “finger-traps,” which tend to constrict radially under axial tension.

As illustrated in the figures, the braid cover 16 is sleeved over the bellows member 14. When the coupler 10 is extended in length, the circumference of the braid cover 16 constricts radially and the braid cover 16 becomes constricted against the bellows member 14. The outer diameter of the bellows member 14 prevents the braid cover 16 from shrinking in diameter any further and thus limits how far the braid cover 16 (and consequently the coupler 10 and its components, including the interlock member 12) may be extended in length.

The combination of the interlock member 12 being at a nearly fully extended length when the bellows member 14 is in a natural uncompressed, unextended length, as described above, and the construction of the braid cover 16, enable the coupler 10 to have improved flexibility and compressibility.

As set forth above, the interlock member ends 22 and 24, the bellows member ends 46 and 48 and the braid cover ends 52 and 54 may be combined together, respectively, with a retainer. The retainer may be comprised of a support ring or end ring 20, a spot weld, a bead of weld 58, a clamping member, any suitable fastener, or any combination thereof. As best illustrated in FIGS. 3 and 4, the retainer may also secure the ends 22, 24, 46, 48, 52 and 54 to an outer surface of the respective end flanges 18. As shown, the end rings 20 are fit on the end flanges 18 in such a manner as to sandwich the ends 22, 24, 46, 48, 52 and 54 between the end flanges 18 and end rings 20. As may be appreciated, the interlock member 12, the bellows member 14, the braid cover 16 and the end rings 20 may be integrally connected to each other by way of spot welds (not shown) or a bead of weld 58. The end rings 20 may further be secured to the flanges 18 by way of a weld 58 or other suitable attachment means. It should be understood, however, that the interlock member 12, bellows member 14 and braid cover 16 may be coupled with the flanges 18 or directly to the exhaust pipes by any suitable fastening means, including welding, clamping, riveting, bolting, screwing or the like.

FIG. 5 illustrates an embodiment of the coupler 10 similar to the one described above, but further including an inner braid member 60 disposed inwardly of the interlock member 12. The inner braid member 60 may serve to further dampen vibrations and provide resistance limiting axial compression of the coupler 10 while allowing for maximum extension and angular flexibility during installation and use. This promotes prolonged life of the interlock member 12 by restricting it from being compressed too far and potentially breaking or crimping its hook portions 30 and 38. Like the outer braid cover 16, the inner braid member 60 may be formed of a plurality of intertwined ribbon-like bundles made up of parallel metallic wire filaments. The angle at which the inner braid member 60 bundles are intertwined may be substantially similar to the angle β at which the outer braid cover bundles 56 are intertwined.

Like the outer braid cover 16, the inner braid member 60, by its nature, cannot extend or compress without changing diameter. Thus, when the inner braid member 60 is compressed in length axially, its circumference expands radially, and vice versa. As shown in FIG. 5, the braid member 60 is sleeved around the interior of the interlock member 12. When the coupler 10 is compressed in length axially, the braid member 60 expands radially and becomes pressed against the interior of the interlock member 12. The interior diameter of the interlock member 12 prevents the braid member 60 from expanding in diameter any further and thus limits how far the braid member 60 (and consequently the coupler 10 and all of its components, including the interlock member 12) may be compressed in length. Just as the outer braid cover 16 provides resistance or restriction limiting the axial growth of the coupler 10, the interior braid member provides resistance or restriction limiting the axial compression of the coupler 10. The braid cover 16 and braid member 60 may work in tandem to ensure that the coupler 10 will not be stretched or compressed too far thereby aiding to prevent premature failure of the components therein, including the interlock member 12 and bellows member 14.

It should be understood that one or both of the outer braid cover 12 and inner braid member 60 may be incorporated into a coupler 10 comprising one of more of a bellows member 14, an interlock member 12 or any combinations thereof. For example, in one embodiment, the coupler 10 may be comprised of a bellows member 14, an outer braid cover 16 disposed around the bellows member 14, and retainers coupling the ends parts of the bellows member 14 and outer braid cover 16 together. The coupler 10 need not include all of the components described here and may optionally only include one of either the inner braid member 60 or the outer braid cover 16. Other suitable combinations of the components described herein may also be utilized to form the coupler 10.

Turning attention now to the manner in which the coupler 10 is manufactured, the coupler 10 is an assembly of a number of components, including an interlock member 12 and a bellows member 14. The interlock member 12 is positioned within the bellows member 14. The ends 22 and 24 of the interlock member 12 are coupled with the ends 46 and 48 of the bellows member 14, respectively, such that when the bellows member 14 is at a natural uncompressed and unextended length, the interlock member 12 is generally at a nearly fully extended length. This is best illustrated in FIG. 3. As set forth above, the coupling of ends 22, 24, 46 and 48 may be achieved by a retainer which may be comprised of a support ring or end ring 20, a spot weld, a bead of weld 58, a clamping member, any suitable fastener, or any combination thereof. As demonstrated in FIGS. 3 and 4, the interlock end 24 and bellows member end 48 may be positioned over an end flange 18. An end ring 20 may then be slid over the ends 24 and 48. Once the ends 24 and 48 are retained between the flange 18 and ring 20, the components may be retained together by a bead of weld 58, one or more spot welds, a clamp, any other suitable fastener or any combinations thereof.

The coupler 10 may also include a braid cover 16 surrounding an outer periphery of the bellows member 14. As set forth above, wire filaments formed into bundles 56, may be intertwined (e.g., interlaced, braided, knitted, woven, looped or the like) together on an elongated mandrel (not shown) to form a flexible, sleeve-like braid cover 16. The bundles 56 may be intertwined on the mandrel such that they are generally disposed of at an angle β relative to a central axis of the mandrel. As set forth above, the angle β can be in a range from about 55° to 80°, and in one embodiment is in a range from about 65° to 75°. Upon the formation of the braid cover 16, it may be assembled with the remainder of the coupler 10. As best shown in FIGS. 3 and 4, the braid cover 16, like the interlock member 12 and bellows member 14, may be retained between the end flange 18 and end ring 20.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A coupler for use in an exhaust system, said coupler comprising:
a flexible bellows member made of metallic material and having a generally cylindrical and repeatedly corrugated shape;
an outer braid cover having a cross-sectional circumference that constricts radially as said outer braid cover is extended in length axially, said outer braid cover surrounding said bellows member in a manner such that said outer braid cover becomes constricted against said bellows member when said outer braid cover is extended in length axially; and
a retainer for combining end parts of said bellows member and outer braid cover.

2. The coupler of claim 1, wherein the constriction of said outer braid cover against said bellows member serves to limit the amount in which said outer braid cover and coupler may be extended in length axially.

3. The coupler of claim 1, wherein said outer braid cover is designed to provide resistance limiting axial growth of said coupler while enabling compression and angular flexibility.

4. The coupler of claim 1, wherein said outer braid cover is comprised of a plurality bundles of metallic filaments, said bundles being intertwined such that said bundles are generally disposed at an angle between about 65° and 75° from a central axis of said coupler.

5. The coupler of claim 1 further comprising an interlock member disposed within said bellows member, said interlock member being axially extendable and contractible and including end parts combined with said end parts of said bellows member and outer braid cover.

6. The coupler of claim 5, wherein when said bellows member is at a natural uncompressed, unextended length, said interlock member is generally at a nearly fully extended length.

7. The coupler of claim 5 further comprising an inner braid member disposed around an interior of said interlock member.

8. The coupler of claim 7, wherein said inner braid member has a cross-sectional circumference that expands radially as said inner braid member is compressed in length axially.

9. The coupler of claim 8, wherein said inner braid member becomes pressed against said interior of said interlock member when said inner braid member is compressed in length axially.

10. The coupler of claim 9, wherein the contact of said inner braid member against said interlock member serves to limit the amount in which said inner braid member and coupler may be compressed in length axially.

11. A coupler for use in an exhaust system, said coupler comprising:
a flexible bellows member made of metallic material and having a generally cylindrical and repeatedly corrugated shape and first and second ends; and
an interlock member disposed within said bellows member, said interlock member being axially extendable and contractible and having first and second ends;
wherein said first and second ends of said bellows member are coupled with said first and second ends of said interlock member, respectively;
wherein when said bellows member is at a natural uncompressed, unextended length, said interlock member is generally at a nearly fully extended length.

12. The coupler of claim 11 further comprising an outer braid cover surrounding said bellows member.

13. The coupler of claim 12, wherein said outer braid cover has a cross-sectional circumference that constricts radially as said outer braid member is extended in length axially.

14. The coupler of claim 13, wherein said outer braid cover becomes constricted against said bellows member when said outer braid cover is extended in length axially.

15. The coupler of claim 14, wherein the constriction of said outer braid cover against said bellows member serves to limit the amount in which said outer braid cover and coupler may be extended in length axially.

16. The coupler of claim 12, wherein said outer braid cover is comprised of a plurality bundles of metallic filaments, said bundles being intertwined such that said bundles are generally disposed at an angle between about 55° and 80° from a central axis of said coupler.

17. The coupler of claim 16, wherein said bundles are generally disposed at an angle between about 65° and 75° from a central axis of said coupler.

18. The coupler of claim 12, wherein said outer braid cover provides resistance limiting axial growth of said coupler while enabling compression and angular flexibility.

19. The coupler of claim 11 further comprising an inner braid member disposed around an interior of said interlock member.

20. The coupler of claim 19, wherein said inner braid member has a cross-sectional circumference that expands radially as said inner braid member is compressed in length axially.

21. The coupler of claim 20, wherein said inner braid member becomes pressed against said interior of said interlock member when said inner braid member is compressed in length axially.

22. The coupler of claim 21, wherein the contact of said inner braid member against said interlock member serves to limit the amount in which said inner braid member and coupler may be compressed in length axially.

23. A method of manufacturing a coupler for use in an exhaust system, said method comprising the steps of:
providing a flexible bellows member having first and second ends;
providing an interlock member having first and second ends;
positioning said interlock member within said bellows member; and
coupling said first and second ends of said bellows member with said first and second ends of said interlock member, respectively, such that when said ends are coupled, said bellows member is at a natural uncompressed, unextended length and said interlock member is generally at a nearly fully extended length.

24. The method of claim 23 further comprising the steps of providing an outer braid cover and positioning said outer braid cover around said bellows member.

25. The method of claim 24, wherein said outer braid cover is designed to provide resistance limiting axial growth of said coupler while enabling compression and angular flexibility.

26. The method of claim 23 further comprising the steps of providing an inner braid member and positioning said inner braid cover around an interior of said interlock member.

27. The method of claim 26, wherein said inner braid member is designed to provide resistance limiting axial compression of said coupler while enabling extension and angular flexibility.
